(19) United States
(12) Patent Application Publication
(10) Pub. No.: US 2024/0089760 A1
(43) Pub. Date: Mar. 14, 2024

(54) DOWNLINK REFERENCE SIGNAL MEASUREMENTS FOR SUPPLEMENTAL UPLINK CARRIERS

(71) Applicant: QUALCOMM Incorporated, San Diego, CA (US)

(72) Inventors: Jae Ho RYU, San Diego, CA (US); Sanghoon KIM, San Jose, CA (US); Changhwan PARK, San Diego, CA (US); Kazuki TAKEDA, Tokyo (JP)

(21) Appl. No.: 17/931,739

(22) Filed: Sep. 13, 2022

(51) Int. Cl. H04W 24/08; H04W 52/10; H04W 52/24; H04W 72/04

(52) U.S. Cl. CPC H04W 24/08; H04W 52/10; H04W 52/242; H04W 72/0453

(57) ABSTRACT

Wireless communications systems, apparatuses, and methods are provided. A method of wireless communication performed by a user equipment (UE) includes receiving, from a network unit, a reference signal in a first frequency band, measuring the reference signal, and transmitting a communication in the first frequency band based on the measurement, wherein the UE is configured with a supplementary uplink (SUL) carrier on the first frequency band.

### TECHNICAL FIELD

This application relates to wireless communication systems, and more particularly, to downlink reference signal measurements for supplemental uplink carriers.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (B Ss), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) may include receiving, from a network unit, a reference signal in a first frequency band; measuring the reference signal; and transmitting a communication in the first frequency band based on the measurement, wherein the UE is configured with a supplementary uplink (SUL) carrier on the first frequency band.

In an additional aspect of the disclosure, a method of wireless communication performed by a network unit may include transmitting, to a user equipment (UE), via a signal in a second frequency band, a configuration associated with a supplemental uplink carrier in a first frequency band, wherein the configuration comprises one or more parameters associated with a reference signal transmitted by the network unit in the first frequency band and receiving, from the UE, an uplink communication in the first frequency band based on the one or more parameters.

In an additional aspect of the disclosure, a user equipment (UE) may include a memory; a transceiver; and at least one processor coupled to the memory and the transceiver, wherein the UE is configured to receive, from a network unit, a reference signal in a first frequency band; measure the reference signal; and transmit a communication in the first frequency band based on the measurement, wherein the UE is configured with a supplementary uplink (SUL) carrier on the first frequency band.

In an additional aspect of the disclosure, a network unit may include a memory; a transceiver; and at least one processor coupled to the memory and the transceiver, wherein the network unit is configured to transmit, to a user equipment (UE), via a signal in a second frequency band, a configuration associated with a supplemental uplink carrier in a first frequency band, wherein the configuration comprises one or more parameters associated with a reference signal transmitted by the network unit in the first frequency band and receive, from the UE, an uplink communication in the first frequency band based on the one or more parameters.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates a wireless communication network according to some aspects of the present disclosure.

FIG. 4A is a signaling diagram of a wireless communication method according to some aspects of the present disclosure.

FIG. 4B illustrates an example of resources associated with reference signal measurements according to some aspects of the present disclosure.

FIG. 5 is a block diagram of an exemplary user equipment (UE) according to some aspects of the present disclosure.

FIG. 6 is a block diagram of an exemplary network unit according to some aspects of the present disclosure.

FIG. 7 is a flow diagram of a communication method according to some aspects of the present disclosure.

FIG. 8 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km2), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNIT) radio band has a minimum OCB requirement of about at least 70 percent (%).

Some sidelink systems may operate over a 20 MHz bandwidth, e.g., for listen before talk (LBT) based channel accessing, in an unlicensed band. ABS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (Cus), one or more distributed units (Dus), or one or more radio units (Rus)). In some aspects, a CU may be implemented within a RAN node, and one or more Dus may be co-located with the CU, or alternatively, may be geographically or virtually distributed throughout one or multiple other RAN nodes. The Dus may be implemented to communicate with one or more Rus. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

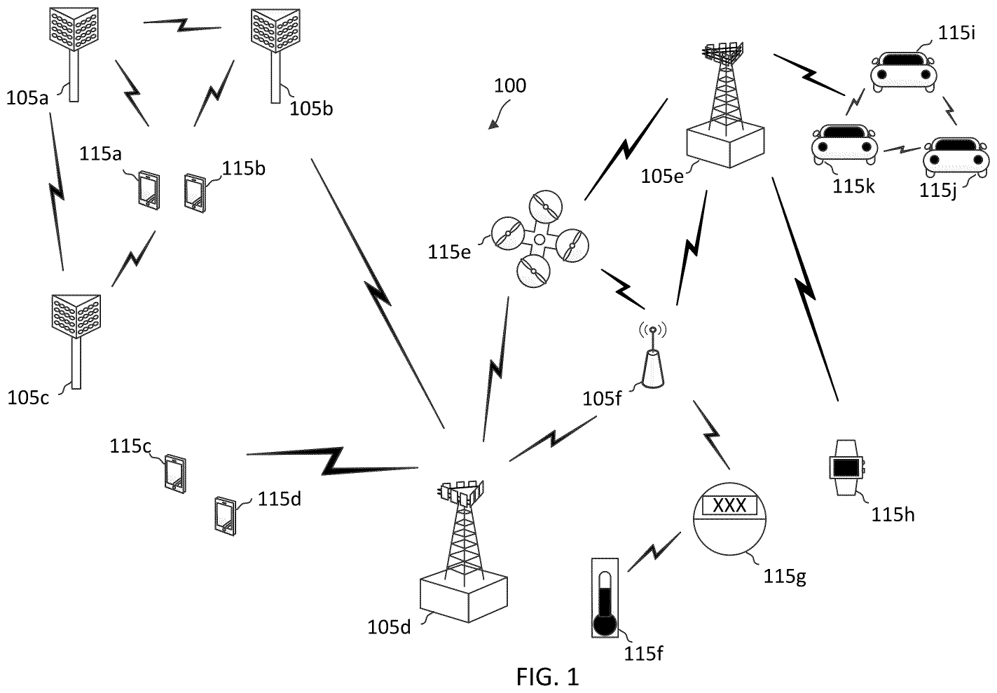

FIG. 1 illustrates a wireless communication network 100 according to some aspects of the present disclosure. The network 100 includes a number of base stations (BSs) 105 and other network entities. A BS 105 may be a station that communicates with Ues 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

ABS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by Ues with service subscriptions with the network provider. A small cell, such as a pico cell, would generally cover a relatively smaller geographic area and may allow unrestricted access by Ues with service subscriptions with the network provider. A small cell, such as a femto cell, would also generally cover a relatively small geographic area (e.g., a home) and, in addition to unrestricted access, may also provide restricted access by Ues having an association with the femto cell (e.g., Ues in a closed subscriber group (CSG), Ues for users in the home, and the like). A BS for a macro cell may be referred to as a macro BS. ABS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. ABS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The Ues 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the Ues 115 that do not include UICCs may also be referred to as IoT devices or internet of everything (IoE) devices. The Ues 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The Ues 115e-115h are examples of various machines configured for communication that access the network 100. The Ues 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between Ues 115.

In operation, the BSs 105a-105c may serve the Ues 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the Ues 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other Ues 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the Ues 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the Ues 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115 may receive a reference signal from a network unit (e.g., the BS 105 or the network unit 600) in a first frequency band. The UE 115 may measure the reference signal. The UE 115 may transmit a communication to the network unit in the first frequency band based on the measurement. In some aspects, the UE 115 may be configured with a supplementary uplink (SUL) carrier on the first frequency band.

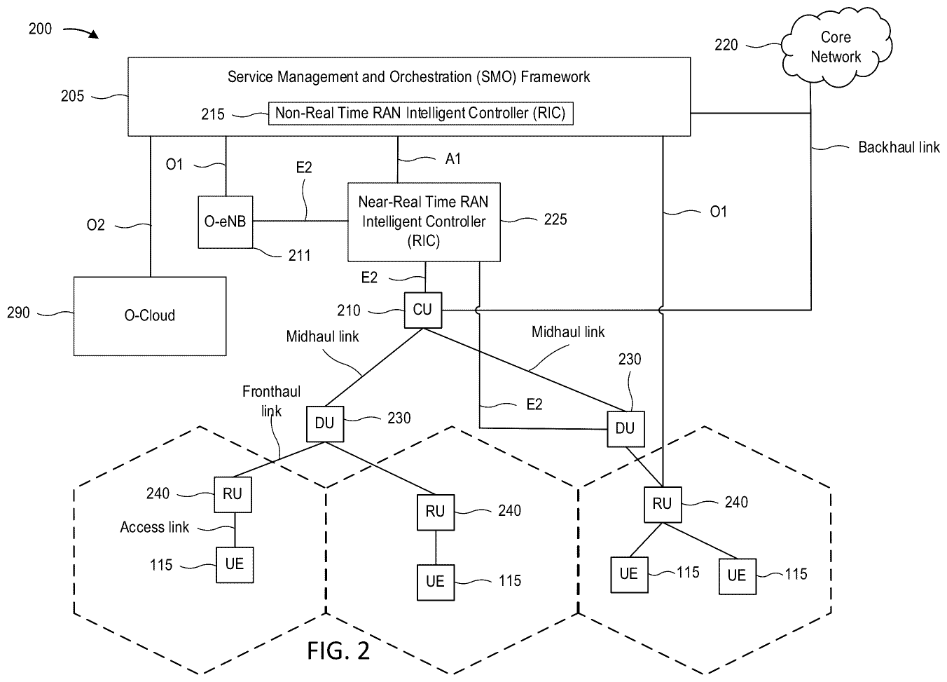

FIG. 2 shows a diagram illustrating an example disaggregated base station 200 architecture. The disaggregated base station 200 architecture may include one or more central units (Cus) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (Rus) 240 via respective fronthaul links. The Rus 240 may communicate with respective Ues 115 via one or more radio frequency (RF) access links. In some implementations, the UE 115 may be simultaneously served by multiple Rus 240.

Each of the units, i.e., the Cus 210, the Dus 230, the Rus 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more Rus 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more Rus 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, Cus 210, Dus 230, Rus 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more Rus 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more Cus 210, one or more Dus 230, or both, as well as an O-eNB, with the Near-RT RIC 225.

In some implementations, to generate A1/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ A1/ML models to perform corrective actions through the SMO Framework 205 (such as reconfiguration via 01) or via creation of RAN management policies (such as A1 policies).

In some aspects, the UE 115 may receive a reference signal from a network unit (the BS 105, the RU 240, the DU 230, the CU 210, and/or the network unit 600) in a first frequency band. The UE 115 may measure the reference signal. The UE 115 may transmit a communication to the network unit in the first frequency band based on the measurement. In some aspects, the UE 115 may be configured with a supplementary uplink (SUL) carrier on the first frequency band.

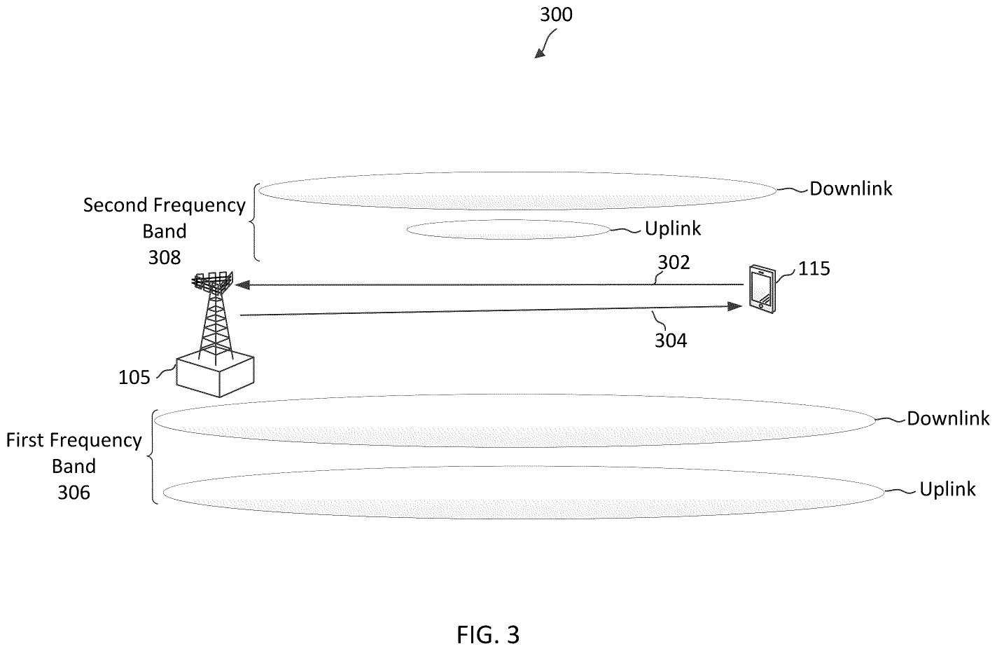

FIG. 3 illustrates a wireless communication network 300 according to some aspects of the present disclosure. In some aspects, the wireless communication network 300 may operate across a range of frequencies that includes multiple frequency bands. For example, referring to FIG. 3, the frequency range (e.g., frequency spectrum) may include the first frequency band 306, a second frequency band 308, a third frequency band, etc. In some aspects, the UE 115 may communicate with the network unit 105 using multiple frequency bands. For example, the UE 115 may communicate with the network unit 105 using the first frequency band 306 and the second frequency band 308. In some aspects, the UE 115 may transmit uplink communications 302 to the network unit 105 using the first frequency band 306 and the second frequency band 308. The network unit 105 may transmit downlink communications 304 to the UE 115 using the second frequency band 308. In some aspects, the first frequency band 306 may be a supplemental uplink carrier for the UE 115. In some instances, the supplemental uplink carrier in the first frequency band 306 may be used when the UE 115 is out of range or otherwise cannot communicate with the network unit 105 using the second frequency band 308.

In some instances, the first frequency band 306 may be a lower frequency band than the second frequency band 308. For example, the first frequency band 306 may be a sub 1 GHz frequency band while the second frequency band 308 may be greater than 1 GHz.

In some aspects, the UE 115 may receive a reference signal from the network unit 105 in the downlink direction of the first frequency band 306. The reference signal may include a synchronization signal block (SSB), a primary synchronization signal (PSS), a secondary synchronization signal (SSS), a cell specific reference signal (CRS), and/or other suitable reference signal. For example, when the network unit 105 operates in a new radio (NR) mode, the reference signal may include a synchronization signal block (SSB), a primary synchronization signal (PSS), and/or a secondary synchronization signal (SSS). When the network unit 105 operates in a long term evolution (LTE) mode, the reference signal may include a cell specific reference signal (CRS).

The UE 115 may perform measurements on the reference signal(s). In some aspects, the UE 115 may transmit a communication to the network unit 105 in the uplink direction of the first frequency band 306 based on the reference signal measurement(s). In the regard, the first frequency band 306 may include a supplemental uplink carrier (SUL). The first frequency band 306 may be lower than the second frequency band 308 and provide additional (e.g., supplemental) uplink coverage for the UE 115. For example, the second frequency band 308 may provide a primary uplink carrier for the UE 115. The coverage range for the first frequency band 306 may be larger than the coverage range for the second frequency band 308 due to the first frequency band 306 being lower than the second frequency band 308. The UE 115 may transmit communications to the network unit 105 using the first frequency band 306 and/or the second frequency band 308 when the UE is in coverage range of the first frequency band 306 and the second frequency band 308. When the UE 115 is in coverage range of the first frequency band 306 and out of coverage range of the second frequency band 308, the UE 115 may transmit communications to the network unit 105 using the first frequency band 306 (e.g., the supplemental uplink carrier).

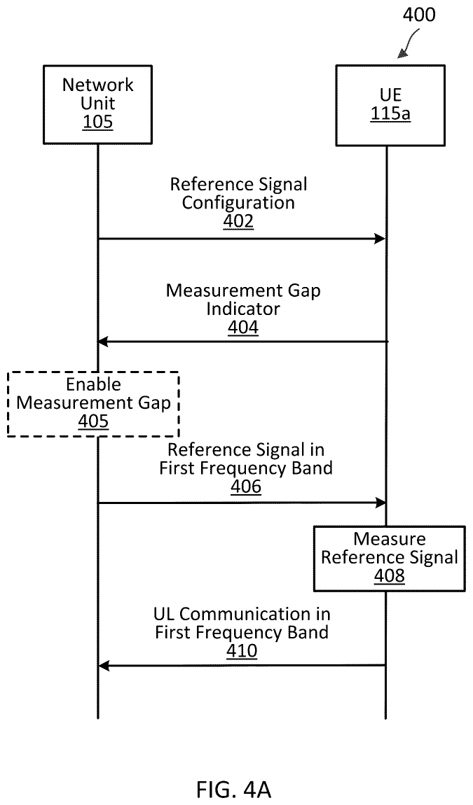

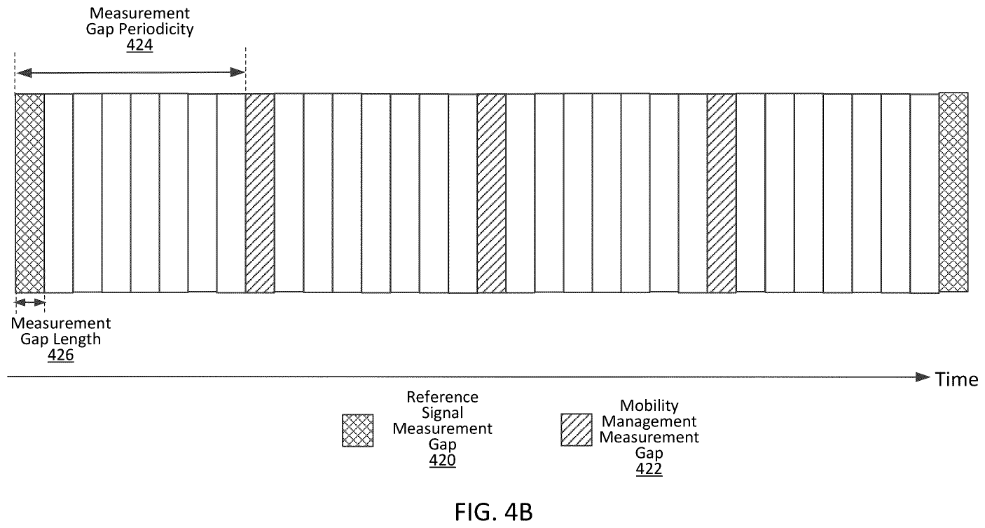

FIG. 4A is a signaling diagram of a wireless communication method 400 according to some aspects of the present disclosure. Actions of the communication method 400 can be executed by a computing device (e.g., a processor, processing circuit, and/or other suitable component) of a communication device or other suitable means for performing the actions. For example, a wireless communication device, such as the UE 115 or UE 500, may utilize one or more components, such as the processor 502, the memory 504, the downlink measurement module 508, the transceiver 510, the modem 512, and the one or more antennas 516, to execute aspects of method 400. A wireless communication device, such as the network unit 105 or 600, may utilize one or more components, such as the processor 602, the memory 604, the downlink measurement module 608, the transceiver 610, the modem 612, and the one or more antennas 616, to execute aspects of method 400.

At action 402, the network unit 105 may transmit a reference signal configuration associated with the first frequency band to the UE 115. In this regard, the network unit 105 may transmit the configuration to the UE 115 in the second frequency band. The network unit 105 may transmit the configuration in a physical broadcast channel (PBCH) communication, a radio resource control (RRC) communication, downlink control information (DCI), a physical downlink control channel (PDCCH) communication, and/or other suitable communication. In some aspects, the UE 115 may transmit a request to the network unit 105 requesting the configuration. In this regard, the UE 115 may transmit the request to the network unit 105 in the second frequency band via uplink control information (UCI), a physical uplink control channel (PUCCH) communication, or other suitable communication.

In some aspects, the UE 115 may receive the reference signal in the first frequency band based on the configuration received in the second frequency band. The configuration may include a radio access technology (RAT) indicator associated with the first frequency band. In this regard, the RAT indicator may indicate the network unit 105 operates a new radio (NR) RAT in the first frequency. In some aspects, the RAT indicator may indicate the network unit 105 operates a long term evolution (LTE) RAT in the first frequency.

In some aspects, the configuration may indicate a frequency resource indicator associated with the reference signal. For example, the configuration may indicate the frequency resources used by the network unit 105 to transmit the reference signal(s) in the first frequency band. In some instances, the frequency resources may be indicated in a frequency domain resource allocation (FDRA). The FDRA may indicate frequency subchannels, subcarrier spacing, carrier frequency, and/or an allowed measurement bandwidth in the first frequency band that carries the reference signal(s).

In some aspects, the configuration may indicate a time resource indicator associated with the reference signal. For example, the configuration may indicate the time resources used by the network unit 105 to transmit the reference signal(s) in the first frequency band. In some instances, the time resources may be indicated in a time domain resource allocation (TDRA). The TDRA may indicate slots, sublots, frames, and/or sub-frames in which the reference signal(s) are transmitted. In some aspects, the time resource indicator associated with the reference signal may include a SSB measurement timing configuration (SMTC).

In some aspects, the configuration may indicate a transmit power associated with the reference signal. For example, the configuration may indicate the transmit power level(s) used by the network unit 105 to transmit the reference signal(s) in the first frequency band. In some aspects, the configuration may indicate one or more transmit power control (TPC) parameters associated with the first frequency band. For example, the TPC parameters may include open loop TPC parameters. For example, the TPC parameters may include an alpha parameter (e.g., a value between 0 and 1) indicating a fractional power control factor based on pathloss compensation. The UE may use the TPC parameter to control the transmit power of a communication transmitted to the network unit 105.

At action 404, the UE 115 may transmit a measurement gap indicator to the network unit 105. The UE 115 may transmit an indicator to the network unit 105 indicating whether or not the UE 115 requires a measurement gap to measure a reference signal. In some aspects, the UE 115 may measure the reference signal based on whether the UE 115 requires a measurement gap to measure the reference signal. The measurement gap may be a time period during which the UE 115 switches its receiver from one frequency band to another. For example, the UE 115 may switch from the first frequency band to the second frequency band during the measurement gap. Additionally or alternatively, the UE 115 may switch from the second frequency band to the first frequency band during the measurement gap.

In some aspects, the UE 115 may require a measurement gap based on receiver capabilities (e.g., receiver of transceiver 510) of the UE 115. For example, the UE 115 may include a receiver capable of simultaneously receiving signals in multiple bands. In this case, the UE 115 may not require a measurement gap as the UE 115 may be able to simultaneously receive signals from the network unit in the second frequency and measure the reference signal(s) from the network unit 105 in the first frequency band. In some aspects, the UE 115 may include a receiver that is not capable of simultaneously receiving signals in multiple bands. In this case, the UE 115 may require a measurement gap to measure the reference signal. When the UE 115 requires a measurement gap, the UE 115 may transmit an indicator to the network unit 105 indicating a measurement gap periodicity (e.g., 20 ms, 40 ms, 80 ms, 160 ms, 320 ms, 640 ms, or other suitable periodicity) and/or a measurement gap length (e.g., 1.5 ms, 3 ms, 3.5 ms, 4 ms, 5.5 ms, 6 ms, or other suitable measurement gap length). During the measurement gap, the UE 115 may switch its receiver from receiving signals in the second frequency band to receiving signals in the first frequency band. The UE 115 may measure the reference signal(s) from the network unit in the first frequency band after the measurement gap when the receiver is configured to receive signals in the first frequency band.

At action 405, the network unit 105 may enable a measurement gap when transmitting a reference signal to the UE 115. The network unit 105 may enable or disable the measurement gap based on the measurement gap indicator received from the UE 115 at action 404.

At action 406, the network unit 105 may transmit one or more reference signal(s) to the UE 115 in the first frequency band. The reference signal may include a synchronization signal block (SSB), a primary synchronization signal (PSS), a secondary synchronization signal (SSS), a cell specific reference signal (CRS), and/or other suitable reference signal. For example, when the network unit 105 operates in a new radio (NR) mode, the reference signal may include a synchronization signal block (SSB), a primary synchronization signal (PSS), and/or a secondary synchronization signal (SSS). When the network unit 105 operates in a long term evolution (LTE) mode, the reference signal may include a cell specific reference signal (CRS).

At action 408, the UE 115 may measure the reference signal(s) received from the network unit in the first frequency band. The UE 115 may measure a received signal strength indicator (RSSI) associated with the reference signal, a reference signal received power (RSRP), and/or other suitable measurement parameter associated with the reference signal. In this regard, the UE 115 may measure the reference signal based on the configuration information from the network unit 105. In some instances, the UE 115 may measure the reference signal without the configuration information from the network unit 105. When the UE 115 measures the reference signal without the configuration information from the network unit 105, the UE 115 may perform a blind signal detection across a frequency range including the first frequency band. In this regard, the UE 115 may monitor (e.g., scan) the frequency range for the reference signal in the first frequency band.

In some aspects, the UE 115 may measure the reference signal based on the configuration. For example, the UE 115 may measure the reference signal based on the RAT indicator associated with the first frequency band, the transmit power associated with the reference signal, the frequency resource indicator associated with the reference signal, and/or the time resource indicator associated with the reference signal.

The UE 115 may determine a pathloss in the first frequency band based on the measured reference signal. For example, the UE 115 may subtract the measured RSRP of the reference signal from the transmit power associated with the reference signal to determine the pathloss. The UE 115 may transmit an indication of the pathloss determination to the network unit 105. The network unit 105 may determine one or more TPC parameters based on the pathloss determination received from the UE 115.

In some aspects, the UE 115 may measure a time synchronization parameter and/or a frequency synchronization parameter associated with the reference signal in the first frequency band. For example, the UE 115 may measure a timing advance parameter and/or a frequency compensation parameter associated with the reference signal.

In some aspects, the UE 115 may measure the RSRP of the reference signal using multiple antennas of the UE 115. The UE 115 may have multiple antennas (e.g., 2, 4, 8, 16, or any suitable number of antennas). Each of the multiple antennas may be oriented in a different direction to enable spatial diversity of the transmitted signals and/or the receive signals. As a non-limiting example, the UE 115 may have a first antenna and a second antenna. The first and second antennas may have main lobes oriented 180 degrees from each other. The UE 115 may measure the RSRP of the reference signal in the first frequency band using both the first and second antennas. The antenna having the highest measured RSRP may be associated with a higher quality channel between the UE 115 and network unit 105.

At action 410, the UE 115 may transmit a communication to the network unit 105 in the first frequency band based on the reference signal measurement(s) at action 408. In this regard, the UE 115 may transmit a PUCCH, a PUSCH, or other suitable communication to the network unit 105. The first frequency band may include a supplemental uplink carrier (SUL). The first frequency band may be lower than the second frequency band and provide additional (e.g., supplemental) uplink coverage for the UE 115. For example, the second frequency band may provide a primary uplink carrier for the UE 115. The coverage range for the first frequency band may be larger than the coverage range for the second frequency band due to the first frequency band being lower than the second frequency band. The UE 115 may transmit communications to the network unit 105 using the first frequency band and/or the second frequency band when the UE 115 is in the coverage range of the first and second frequency bands. When the UE 115 is in coverage range of the first frequency band and out of coverage range of the second frequency band, the UE 115 may transmit communications to the network unit 105 using the first frequency band (e.g., the supplemental uplink carrier).

In some aspects, the UE 115 may transmit the communication using a transmit power based on a measured pathloss. In this regard, the UE 115 may determine a pathloss based on the reference signal measurement(s) at action 408. The UE may transmit the communication using a transmit power based on the determined pathloss.

In some aspects, the UE 115 may transmit the communication based on a time synchronization parameter (e.g., timing advance parameter) and/or a frequency synchronization parameter (e.g., doppler shift) associated with the reference signal. In this regard, the UE 115 may determine the time synchronization parameter and/or a frequency synchronization parameter based on the reference signal measurement(s) at action 408. The UE 115 may transmit the communication based on the time synchronization parameter and/or the frequency synchronization parameter.

In some aspects, the UE 115 may transmit the communication to the network unit 105 using one or more antennas of the multiple antennas having the highest channel quality. The UE 115 may determine which antenna(s) of the multiple antennas has the highest channel quality based on a highest RSRP among the multiple antennas measured at action 408.

FIG. 4B illustrates an example of resources associated with reference signal measurements according to some aspects of the present disclosure. In FIG. 4B, the X-axis may represent time in some arbitrary units. In some aspects, the UE may measure the reference signal based on whether the UE requires a measurement gap to measure the reference signal. The measurement gap may be a time period during which the UE switches its receiver from one frequency band to another.

The UE may require a measurement gap based on receiver capabilities (e.g., receiver of transceiver 510) of the UE. For example, the UE may include a receiver capable of simultaneously receiving signals in multiple bands. In this case, the UE may not require a measurement gap as the UE may be able to simultaneously receive signals from the network unit in the second frequency and measure the reference signal(s) from the network unit in the first frequency band. In some aspects, the UE may include a receiver that is not capable of simultaneously receiving signals in multiple bands. In this case, the UE may require a measurement gap to measure the reference signal.

In some aspects, the UE may transmit an indicator to the network unit indicating whether or not the UE requires a measurement gap to measure the reference signal. When the UE requires a measurement gap, the UE may transmit an indicator to the network unit indicating a measurement gap periodicity 424 (e.g., 20 ms, 40 ms, 80 ms, 160 ms, 320 ms, 640 ms, or other suitable periodicity) and/or a measurement gap length 426 (e.g., 1.5 ms, 3 ms, 3.5 ms, 4 ms, 5.5 ms, 6 ms, or other suitable measurement gap length). The UE may measure the reference signal from the network unit in the first frequency band during the measurement gap. The measurement gap periodicity 424 may be associated with a periodicity at which the network unit refrains from transmitting to the UE in the second frequency band. In some aspects, the reference signal measurement gap periodicity may be a multiple and/or fraction of a mobility management measurement gap periodicity. The UE may measure the reference signal during the measurement gap at the multiple and/or fraction of the measurement gap periodicity. In this way, measurement gaps may be used (e.g., shared) for both mobility management measurements and reference signal measurements. For example, as shown in FIG. 4B, the mobility management measurement gap 422 may occur 3 times (e.g. or any number of times) as frequently as the reference signal measurement gap 420. In some aspects, the sharing of the measurement gaps for reference signal measurements and mobility management measurements may be based on a number of inter-frequency layers associated with mobility management measurements by the UE.

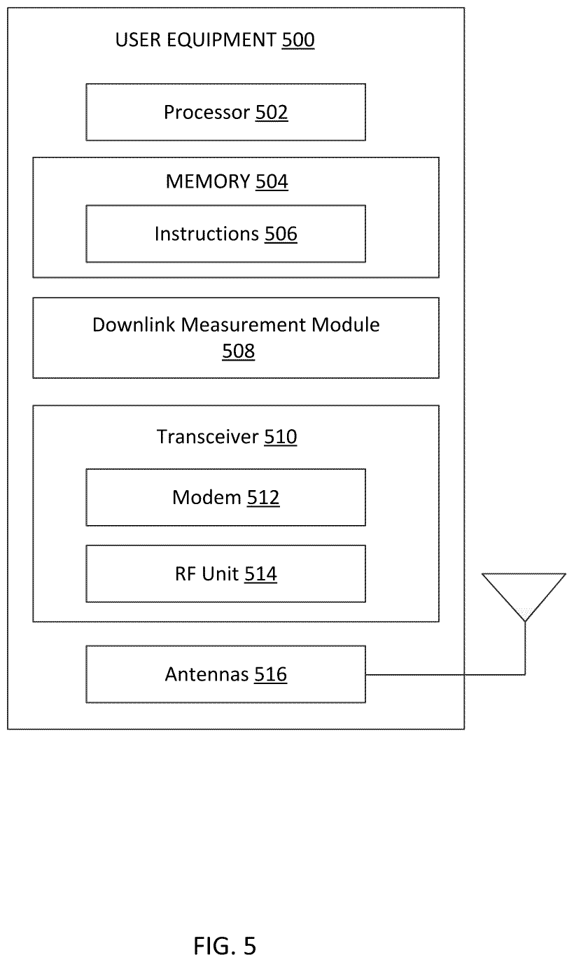

FIG. 5 is a block diagram of an exemplary UE 500 according to some aspects of the present disclosure. The UE 500 may be the UE 115 in the network 100, 200, or 300 as discussed above. As shown, the UE 500 may include a processor 502, a memory 504, a downlink measurement module 508, a transceiver 510 including a modem subsystem 512 and a radio frequency (RF) unit 514, and one or more antennas 516. These elements may be coupled with each other and in direct or indirect communication with each other, for example via one or more buses.

The processor 502 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 504 includes a non-transitory computer-readable medium. The memory 504 may store instructions 506. The instructions 506 may include instructions that, when executed by the processor 502, cause the processor 502 to perform the operations described herein with reference to the UEs 115 in connection with aspects of the present disclosure, for example, aspects of FIGS. 3, 4A and 4B. Instructions 506 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The downlink measurement module 508 may be implemented via hardware, software, or combinations thereof. For example, the downlink measurement module 508 may be implemented as a processor, circuit, and/or instructions 506 stored in the memory 504 and executed by the processor 502. In some aspects, the downlink measurement module 508 may implement the aspects of FIGS. 3, 4A, and 4B. For example, the downlink measurement module 508 may receive, from a network unit, a reference signal in a first frequency band. The downlink measurement module 508 may measure the reference signal and transmit a communication in the first frequency band based on the measurement. The UE may be configured with a supplementary uplink (SUL) carrier on the first frequency band.

As shown, the transceiver 510 may include the modem subsystem 512 and the RF unit 514. The transceiver 510 can be configured to communicate bi-directionally with other devices, such as the BSs 105 and/or the Ues 115. The modem subsystem 512 may be configured to modulate and/or encode the data from the memory 504 and the according to a modulation and coding scheme (MCS), e.g., a low-density parity check (LDPC) coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data from the modem subsystem 512 (on outbound transmissions) or of transmissions originating from another source such as a UE 115 or a BS 105. The RF unit 514 may be further configured to perform analog beamforming in conjunction with the digital beamforming. Although shown as integrated together in transceiver 510, the modem subsystem 512 and the RF unit 514 may be separate devices that are coupled together to enable the UE 500 to communicate with other devices.

The RF unit 514 may provide the modulated and/or processed data, e.g. data packets (or, more generally, data messages that may contain one or more data packets and other information), to the antennas 516 for transmission to one or more other devices. The antennas 516 may further receive data messages transmitted from other devices. The antennas 516 may provide the received data messages for processing and/or demodulation at the transceiver 510. The antennas 516 may include multiple antennas of similar or different designs in order to sustain multiple transmission links. The RF unit 514 may configure the antennas 516.

In some instances, the UE 500 can include multiple transceivers 510 implementing different RATs (e.g., NR and LTE). In some instances, the UE 500 can include a single transceiver 510 implementing multiple RATs (e.g., NR and LTE). In some instances, the transceiver 510 can include various components, where different combinations of components can implement RATs.

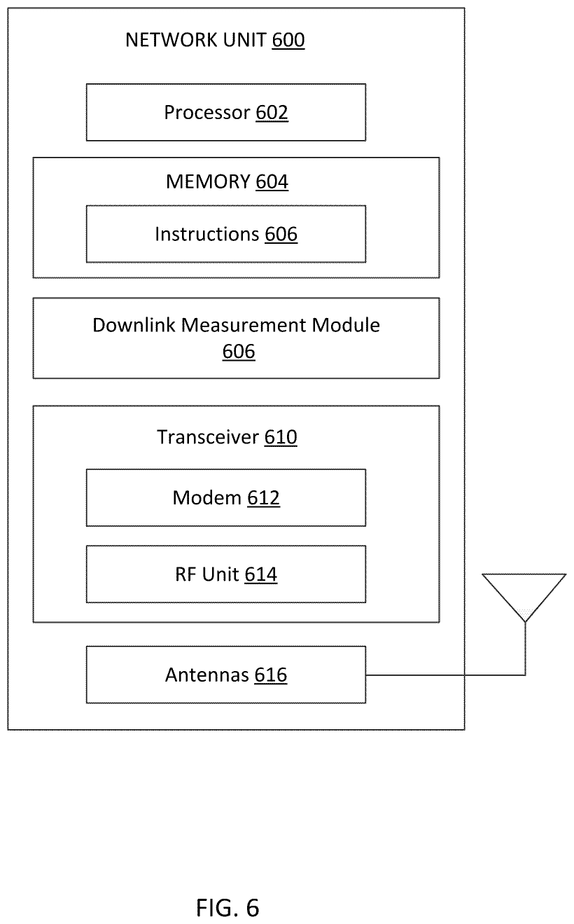

FIG. 6 is a block diagram of an exemplary network unit 600 according to some aspects of the present disclosure. The network unit 600 may be the BS 105, the CU 210, the DU 230, or the RU 240, as discussed above. As shown, the network unit 600 may include a processor 602, a memory 604, a downlink measurement module 608, a transceiver 610 including a modem subsystem 612 and a RF unit 614, and one or more antennas 616. These elements may be coupled with each other and in direct or indirect communication with each other, for example via one or more buses.

The processor 602 may have various features as a specific-type processor. For example, these may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 604 may include a non-transitory computer-readable medium. The memory 604 may store instructions 606. The instructions 606 may include instructions that, when executed by the processor 602, cause the processor 602 to perform operations described herein, for example, aspects of FIGS. 3, 4A, and 4B. Instructions 606 may also be referred to as code, which may be interpreted broadly to include any type of computer-readable statement(s).

The downlink measurement module 608 may be implemented via hardware, software, or combinations thereof. For example, the downlink measurement module 608 may be implemented as a processor, circuit, and/or instructions 606 stored in the memory 604 and executed by the processor 602.

In some aspects, the downlink measurement module 608 may implement the aspects of FIGS. 3, 4A, and 4B. For example, the downlink measurement module 608 may transmit, to a user equipment (UE), via a signal in a second frequency band, a configuration associated with a supplemental uplink carrier in a first frequency band. The configuration may comprise one or more parameters associated with a reference signal transmitted by the network unit in the first frequency band. The downlink measurement module 608 may receive, from the UE, an uplink communication in the first frequency band based on the one or more parameters. Additionally or alternatively, the downlink measurement module 608 can be implemented in any combination of hardware and software, and may, in some implementations, involve, for example, processor 602, memory 604, instructions 606, transceiver 610, and/or modem 612.

As shown, the transceiver 610 may include the modem subsystem 612 and the RF unit 614. The transceiver 610 can be configured to communicate bi-directionally with other devices, such as the UEs 115 and/or 500. The modem subsystem 612 may be configured to modulate and/or encode data according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or UE 500. The RF unit 614 may be further configured to perform analog beamforming in conjunction with the digital beamforming. Although shown as integrated together in transceiver 610, the modem subsystem 612 and/or the RF unit 614 may be separate devices that are coupled together at the network unit 600 to enable the network unit 600 to communicate with other devices.

The RF unit 614 may provide the modulated and/or processed data, e.g. data packets (or, more generally, data messages that may contain one or more data packets and other information), to the antennas 616 for transmission to one or more other devices. This may include, for example, a configuration indicating a plurality of sub-slots within a slot according to aspects of the present disclosure. The antennas 616 may further receive data messages transmitted from other devices and provide the received data messages for processing and/or demodulation at the transceiver 610. The antennas 616 may include multiple antennas of similar or different designs in order to sustain multiple transmission links.

In some instances, the network unit 600 can include multiple transceivers 610 implementing different RATs (e.g., NR and LTE). In some instances, the network unit 600 can include a single transceiver 610 implementing multiple RATs (e.g., NR and LTE). In some instances, the transceiver 610 can include various components, where different combinations of components can implement RATs.

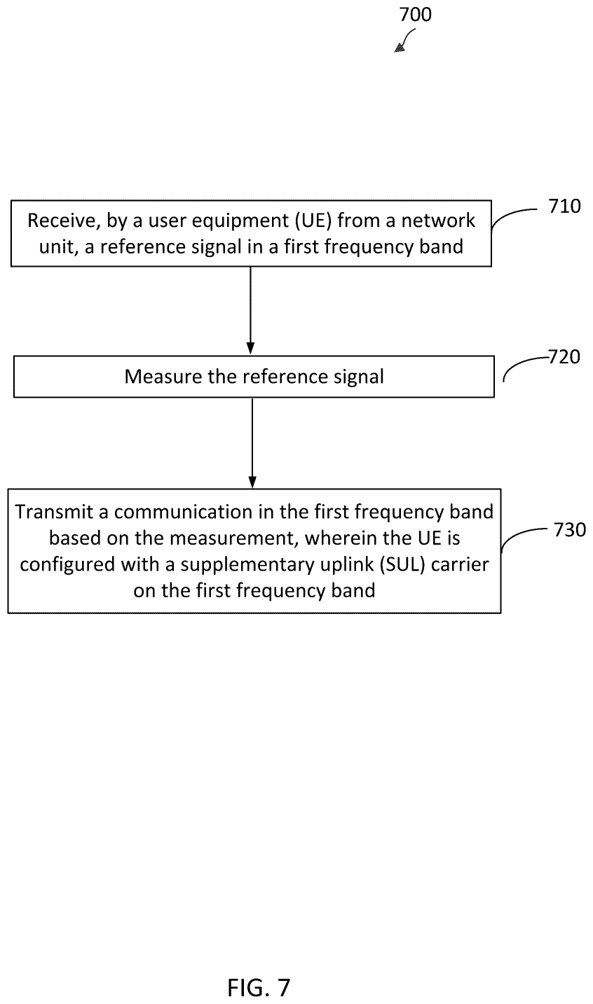

FIG. 7 is a flow diagram of a communication method 700 according to some aspects of the present disclosure. Aspects of the method 700 can be executed by a computing device (e.g., a processor, processing circuit, and/or other suitable component) of a wireless communication device or other suitable means for performing the actions. For example, a wireless communication device, such as the UE 115 or the UE 500, may utilize one or more components, such as the processor 502, the memory 504, the downlink measurement module 508, the transceiver 510, the modem 512, and the one or more antennas 516, to execute aspects of method 700. The method 700 may employ similar mechanisms as in the networks 100, 200, and 300 and the aspects and actions described with respect to FIGS. 3, 4A, and 4B. As illustrated, the method 700 includes a number of enumerated actions, but the method 700 may include additional actions before, after, and in between the enumerated actions. In some aspects, one or more of the enumerated actions may be omitted or performed in a different order.

At action 710, the method 700 includes a UE (e.g., the UE 115 or the UE 500) receiving a reference signal from a network unit (e.g., the BS 105, the RU 240, the DU 230, the CU 210, and/or the network unit 600). The reference signal may include a synchronization signal block (SSB), a primary synchronization signal (PSS), a secondary synchronization signal (SSS), a cell specific reference signal (CRS), and/or other suitable reference signal. For example, when the network unit operates in a new radio (NR) mode, the reference signal may include a synchronization signal block (SSB), a primary synchronization signal (PSS), and/or a secondary synchronization signal (SSS). When the network unit operates in a long term evolution (LTE) mode, the reference signal may include a cell specific reference signal (CRS).

In some aspects, the network unit may operate across a range of frequencies that includes multiple frequency bands. For example, referring to FIG. 3, the frequency range (e.g., a frequency spectrum) may include the first frequency band 306, a second frequency band 308, a third frequency band, etc. In some aspects, the UE 115 may communicate with the network unit 105 using multiple frequency bands. For example, the UE 115 may communicate with the network unit 105 using the first frequency band 306 and the second frequency band 308. In some aspects, the UE 115 may transmit uplink 302 communications to the network unit 105 using the first frequency band 306 and the second frequency band 308. The network unit 105 may transmit downlink 304 communications to the UE 115 using the second frequency band 308. In some aspects, the first frequency band 306 may be a supplemental uplink carrier for the UE 115. In some instances, the supplemental uplink carrier in the first frequency band 306 may be used when the UE 115 is out of range or otherwise cannot communicate with the network unit 105 using the second frequency band 308.

In some aspects, the UE may receive the reference signal in the first frequency band. In some instances, the first frequency band may be a lower frequency band than the second frequency band. For example, the first frequency band may be a sub 1 GHz frequency band while the second frequency band may be greater than 1 GHz.

In some aspects, the UE may receive a configuration associated with the first frequency band. In this regard, the UE may receive the configuration in the second frequency band. The UE may receive the configuration in a physical broadcast channel (PBCH) communication, a radio resource control (RRC) communication, downlink control information (DCI), a physical downlink control channel (PDCCH) communication, and/or other suitable communication. In some aspects, the UE may transmit a request to the network unit requesting the configuration. In this regard, the UE may transmit the request to the network unit in the second frequency band via uplink control information (UCI), a physical uplink control channel (PUCCH) communication, or other suitable communication.

In some aspects, the UE may receive the reference signal in the first frequency band based on the configuration received in the second frequency band. The configuration may include a radio access technology (RAT) indicator associated with the first frequency band. In this regard, the RAT indicator may indicate the network unit operates a new radio (NR) RAT in the first frequency. In some aspects, the RAT indicator may indicate the network unit operates a long term evolution (LTE) RAT in the first frequency.

In some aspects, the configuration may indicate a frequency resource indicator associated with the reference signal. For example, the configuration may indicate the frequency resources used by the network unit to transmit the reference signal(s) in the first frequency band. In some instances, the frequency resources may be indicated in a frequency domain resource allocation (FDRA). The FDRA may indicate frequency subchannels, subcarrier spacing, carrier frequency, and/or an allowed measurement bandwidth in the first frequency band that carries the reference signal(s).

In some aspects, the configuration may indicate a time resource indicator associated with the reference signal. For example, the configuration may indicate the time resources used by the network unit to transmit the reference signal(s) in the first frequency band. In some instances, the time resources may be indicated in a time domain resource allocation (TDRA). The TDRA may indicate slots, sublots, frames, and/or sub-frames in which the reference signal(s) are transmitted. In some aspects, the time resource indicator associated with the reference signal may include a SSB measurement timing configuration (SMTC).

In some aspects, the configuration may indicate a transmit power associated with the reference signal. For example, the configuration may indicate the transmit power level(s) used by the network unit to transmit the reference signal(s) in the first frequency band. In some aspects, the configuration may indicate one or more transmit power control (TPC) parameters associated with the first frequency band. For example, the TPC parameters may include open loop TPC parameters. For example, the TPC parameters may include an alpha parameter (e.g., a value between 0 and 1) indicating a fractional power control factor based on pathloss compensation. As discussed below, in some instances the UE may use the TPC parameter to control the transmit power of a communication transmitted at action 730.

At action 720, the method 700 includes the UE measuring the reference signal received from the network unit in the first frequency band. The UE may measure a received signal strength indicator (RSSI) associated with the reference signal, a reference signal received power (RSRP), and/or other suitable measurement parameter associated with the reference signal. In this regard, the UE may measure the reference signal based on the configuration information from the network unit. In some instances, the UE may measure the reference signal without the configuration information from the network unit. When the UE measures the reference signal without the configuration information from the network unit, the UE may perform a blind signal detection across a frequency range including the first frequency band. In this regard, the UE may monitor (e.g., scan) the frequency range for the reference signal in the first frequency band.

In some aspects, the UE may measure the reference signal based on the configuration. For example, the UE may measure the reference signal based on the RAT indicator associated with the first frequency band, the transmit power associated with the reference signal, the frequency resource indicator associated with the reference signal, and/or the time resource indicator associated with the reference signal.

The UE may determine a pathloss in the first frequency band based on the measured reference signal. For example, the UE may subtract the measured RSRP of the reference signal from the transmit power associated with the reference signal to determine the pathloss. The UE may transmit an indication of the pathloss determination to the network unit. The network unit may determine one or more TPC parameters based on the pathloss determination received from the UE.

In some aspects, the UE may measure the reference signal based on whether the UE requires a measurement gap to measure the reference signal. The measurement gap may be a time period during which the UE switches its receiver from one frequency band to another. For example, the UE may switch from the first frequency band to the second frequency band during the measurement gap. Additionally or alternatively, the UE may switch from the second frequency band to the first frequency band during the measurement gap.

The UE may require a measurement gap based on receiver capabilities (e.g., receiver of transceiver 510) of the UE. For example, the UE may include a receiver capable of simultaneously receiving signals in multiple bands. In this case, the UE may not require a measurement gap as the UE may be able to simultaneously receive signals from the network unit in the second frequency and measure the reference signal(s) from the network unit in the first frequency band. In some aspects, the UE may include a receiver that is not capable of simultaneously receiving signals in multiple bands. In this case, the UE may require a measurement gap to measure the reference signal. During the measurement gap, the UE may switch its receiver from receiving signals in the second frequency band to receiving signals in the first frequency band. The UE may measure the reference signal(s) from the network unit in the first frequency band after the measurement gap when the receiver is configured to receive signals in the first frequency band.

In some aspects, the UE may transmit an indicator to the network unit indicating whether or not the UE requires a measurement gap to measure the reference signal. When the UE requires a measurement gap, the UE may transmit an indicator to the network unit indicating a measurement gap periodicity (e.g., 20 ms, 40 ms, 80 ms, 160 ms, 320 ms, 640 ms, or other suitable periodicity) and/or a measurement gap length (e.g., 1.5 ms, 3 ms, 3.5 ms, 4 ms, 5.5 ms, 6 ms, or other suitable measurement gap length). The measurement gap may be based on the measurement gap periodicity and/or the measurement gap length. The measurement gap length may be a period of time during which the network unit refrains from transmitting to the UE in the second frequency band. The UE may measure the reference signal from the network unit in the first frequency band during the measurement gap. The measurement gap periodicity may be associated with a periodicity at which the network unit refrains from transmitting to the UE in the second frequency band. In some aspects, the measurement gap periodicity may be a multiple and/or fraction of a mobility management measurement gap periodicity. The UE may measure the reference signal during the measurement gap at the multiple and/or fraction of the mobility measurement gap periodicity. In this way, measurement gaps may be used (e.g., shared) for both mobility management measurements and reference signal measurements. For example, the mobility management measurement gap periodicity may be 20 ms, 40 ms, 80 ms, or other suitable periodicity while the reference signal measurement gap periodicity may be an integer multiple (e.g., 2, 4, 8, 10, 16, etc.) of the mobility management measurement gap periodicity. In some aspects, the multiple of the mobility management measurement gap periodicity may be based on a number of inter-frequency layers associated with mobility management measurements by the UE.

In some aspects, the UE may measure a time synchronization parameter and/or a frequency synchronization parameter associated with the reference signal in the first frequency band. For example, the UE may measure a timing advance parameter and/or a frequency compensation parameter associated with the reference signal.

In some aspects, the UE may measure the RSRP of the reference signal using multiple antennas of the UE. The UE may have multiple antennas (e.g., 2, 4, 8, 16, or any suitable number of antennas). Each of the multiple antennas may be oriented in a different direction to enable spatial diversity of the transmitted signals and/or the receive signals. As a non-limiting example, the UE may have a first antenna and a second antenna. The first and second antennas may have main lobes oriented 180 degrees from each other. The UE may measure the RSRP of the reference signal in the first frequency band using both the first and second antennas. The antenna having the highest measured RSRP may be associated with a higher quality channel between the UE and network unit.

At action 730, the method 700 includes the UE transmitting a communication in the first frequency band based on the reference signal measurement(s) at action 720. In the regard, the first frequency band may include a supplemental uplink carrier (SUL). The first frequency band may be lower than the second frequency band and provide additional (e.g., supplemental) uplink coverage for the UE. For example, the second frequency band may provide a primary uplink carrier for the UE. The coverage range for the first frequency band may be larger than the coverage range for the second frequency band due to the first frequency band being lower than the second frequency band. The UE may transmit communications to the network unit using the first frequency band and/or the second frequency band when the UE is in the coverage range of the first and second frequency bands. When the UE is in coverage range of the first frequency band and out of coverage range of the second frequency band, the UE may transmit communications to the network unit using the first frequency band (e.g., the supplemental uplink carrier).

In some aspects, the UE may transmit the communication using a transmit power based on a measured pathloss. In this regard, the UE may determine a pathloss based on the reference signal measurement(s) at action 720. The UE may transmit the communication using a transmit power based on the determined pathloss.

In some aspects, the UE may transmit the communication based on a time synchronization parameter (e.g., timing advance parameter) and/or a frequency synchronization parameter (e.g., doppler shift) associated with the reference signal. In this regard, the UE may determine the time synchronization parameter and/or a frequency synchronization parameter based on the reference signal measurement(s) at action 720. The UE may transmit the communication based on the time synchronization parameter and/or the frequency synchronization parameter.

In some aspects, the UE may transmit the communication to the network unit using one or more antennas of the multiple antennas having the highest channel quality. The UE may determine which antenna(s) of the multiple antennas has the highest channel quality based on a highest RSRP among the multiple antennas measured at action 720.

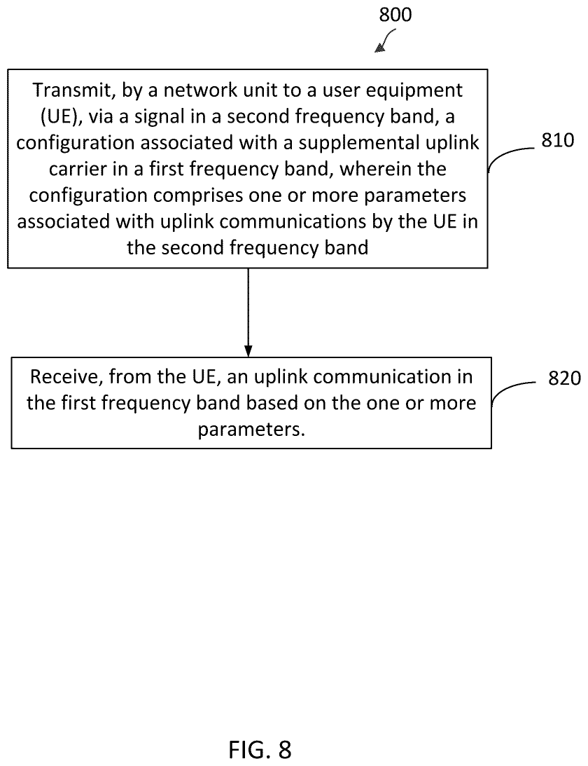

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the actions. For example, a wireless communication device, such as the BS 105, the RU 240, the DU 230, the CU 210, and/or the network unit 600, may utilize one or more components, such as the processor 602, the memory 604, the downlink measurement module 608, the transceiver 610, the modem 612, and the one or more antennas 616, to execute aspects of method 800. The method 800 may employ similar mechanisms as in the networks 100, 200, and 300 and the aspects and actions described with respect to FIGS. 3, 4A, and 4B. As illustrated, the method 800 includes a number of enumerated actions, but the method 800 may include additional actions before, after, and in between the enumerated actions. In some aspects, one or more of the enumerated actions may be omitted or performed in a different order.

At action 810, the method 800 includes a network unit (e.g., the BS 105, the RU 240, the DU 230, the CU 210, and/or the network unit 600) transmitting a signal to a UE (e.g., the UE 115 or the UE 500) in a second frequency band. The signal may include a configuration associated with a supplemental uplink carrier in a first frequency band. In this regard, the network unit may transmit the configuration in the second frequency band. The network unit may transmit the configuration in a physical broadcast channel (PBCH) communication, a radio resource control (RRC) communication, downlink control information (DCI), a physical downlink control channel (PDCCH) communication, and/or other suitable communication. In some aspects, the network unit may receive a request from the UE requesting the configuration. In this regard, the UE may transmit the request to the network unit in the second frequency band via uplink control information (UCI), a physical uplink control channel (PUCCH) communication, or other suitable communication.

In some aspects, the network unit may transmit a reference signal to the UE in the first frequency band. The reference signal may include a synchronization signal block (SSB), a primary synchronization signal (PSS), a secondary synchronization signal (SSS), a cell specific reference signal (CRS), and/or other suitable reference signal. For example, when the network unit operates in a new radio (NR) mode, the reference signal may include a synchronization signal block (SSB), a primary synchronization signal (PSS), and/or a secondary synchronization signal (SSS). When the network unit operates in a long term evolution (LTE) mode, the reference signal may include a cell specific reference signal (CRS).

In some aspects, the network unit may operate across a range of frequencies that includes multiple frequency bands. For example, referring to FIG. 3, the frequency range (e.g., a frequency spectrum) may include the first frequency band 306, a second frequency band 308, a third frequency band, etc. In some aspects, the UE 115 may communicate with the network unit 105 using multiple frequency bands. For example, the UE 115 may communicate with the network unit 105 using the first frequency band 306 and the second frequency band 308. In some aspects, the UE 115 may transmit uplink 302 communications to the network unit 105 using the first frequency band 306 and the second frequency band 308. The network unit 105 may transmit downlink 304 communications to the UE 115 using the second frequency band 308. In some aspects, the first frequency band 306 may be a supplemental uplink carrier for the UE 115. In some instances, the supplemental uplink carrier in the first frequency band 306 may be used when the UE 115 is out of range or otherwise cannot communicate with the network unit 105 using the second frequency band 308.

In some aspects, the network unit may transmit the reference signal in the first frequency band. In some instances, the first frequency band may be a lower frequency band than the second frequency band. For example, the first frequency band may be a sub 1 GHz frequency band while the second frequency band may be greater than 1 GHz.

In some aspects, the network unit may transmit the reference signal in the first frequency band based on the configuration transmitted in the second frequency band. The configuration may include a radio access technology (RAT) indicator associated with the first frequency band. In this regard, the RAT indicator may indicate the network unit operates a new radio (NR) RAT in the first frequency. In some aspects, the RAT indicator may indicate the network unit operates a long term evolution (LTE) RAT in the first frequency.

In some aspects, the configuration may indicate a frequency resource indicator associated with the reference signal. For example, the configuration may indicate the frequency resources used by the network unit to transmit the reference signal(s) in the first frequency band. In some instances, the frequency resources may be indicated in a frequency domain resource allocation (FDRA). The FDRA may indicate frequency subchannels, subcarrier spacing, carrier frequency, and/or an allowed measurement bandwidth in the first frequency band that carries the reference signal(s).

In some aspects, the configuration may indicate a time resource indicator associated with the reference signal. For example, the configuration may indicate the time resources used by the network unit to transmit the reference signal(s) in the first frequency band. In some instances, the time resources may be indicated in a time domain resource allocation (TDRA). The TDRA may indicate slots, sublots, frames, and/or sub-frames in which the reference signal(s) are transmitted. In some aspects, the time resource indicator associated with the reference signal may include a SSB measurement timing configuration (SMTC).

In some aspects, the configuration may indicate a transmit power associated with the reference signal. For example, the configuration may indicate the transmit power level(s) used by the network unit to transmit the reference signal(s) in the first frequency band. In some aspects, the configuration may indicate one or more transmit power control (TPC) parameters associated with the first frequency band. For example, the TPC parameters may include open loop TPC parameters. For example, the TPC parameters may include an alpha parameter (e.g., a value between 0 and 1) indicating a fractional power control factor based on pathloss compensation. In some instances the UE may use the TPC parameter to control the transmit power of a communication transmitted to the network unit at action 820.

In some aspects, the UE may measure the reference signal received from the network unit in the first frequency band. The UE may measure a received signal strength indicator (RSSI) associated with the reference signal, a reference signal received power (RSRP), and/or other suitable measurement parameter associated with the reference signal. In this regard, the UE may measure the reference signal based on the configuration information from the network unit. In some instances, the UE may measure the reference signal without the configuration information from the network unit. When the UE measures the reference signal without the configuration information from the network unit, the UE may perform a blind signal detection across a frequency range including the first frequency band. In this regard, the UE may monitor (e.g., scan) the frequency range for the reference signal in the first frequency band.

In some aspects, the UE may measure the reference signal based on the configuration. For example, the UE may measure the reference signal based on the RAT indicator associated with the first frequency band, the transmit power associated with the reference signal, the frequency resource indicator associated with the reference signal, and/or the time resource indicator associated with the reference signal.

The UE may determine a pathloss in the first frequency band based on the measured reference signal. For example, the UE may subtract the measured RSRP of the reference signal from the transmit power associated with the reference signal to determine the pathloss. The UE may transmit an indication of the pathloss determination to the network unit. The network unit may determine one or more TPC parameters based on the pathloss determination received from the UE.

In some aspects, the UE may measure the reference signal based on whether the UE requires a measurement gap to measure the reference signal. The measurement gap may be a time period during which the UE switches its receiver from one frequency band to another. For example, the network unit and/or the UE may switch from the first frequency band to the second frequency band during the measurement gap. Additionally or alternatively, the network unit and/or the UE may switch from the second frequency band to the first frequency band during the measurement gap.

The UE may require a measurement gap based on receiver capabilities (e.g., receiver of transceiver 510) of the UE. For example, the UE may include a receiver capable of simultaneously receiving signals in multiple bands. In this case, the UE may not require a measurement gap as the UE may be able to simultaneously receive signals from the network unit in the second frequency and measure the reference signal(s) from the network unit in the first frequency band. In some aspects, the UE may include a receiver that is not capable of simultaneously receiving signals in multiple bands. In this case, the UE may require a measurement gap to measure the reference signal. During the measurement gap, the UE may switch its receiver from receiving signals in the second frequency band to receiving signals in the first frequency band. The UE may measure the reference signal(s) from the network unit in the first frequency band after the measurement gap when the receiver is configured to receive signals in the first frequency band.

In some aspects, the network unit may receive an indicator from the UE indicating whether or not the UE requires a measurement gap to measure the reference signal. When the UE requires a measurement gap, the network unit may receive an indicator from the UE indicating a measurement gap periodicity (e.g., 20 ms, 40 ms, 80 ms, 160 ms, 320 ms, 640 ms, or other suitable periodicity) and/or a measurement gap length (e.g., 1.5 ms, 3 ms, 3.5 ms, 4 ms, 5.5 ms, 6 ms, or other suitable measurement gap length). The measurement gap may be based on the measurement gap periodicity and/or the measurement gap length. The measurement gap length may be a period of time during which the network unit refrains from transmitting to the UE in the second frequency band. The UE may measure the reference signal from the network unit in the first frequency band during the measurement gap. The measurement gap periodicity may be associated with a periodicity at which the network unit refrains from transmitting to the UE in the second frequency band. In some aspects, the measurement gap periodicity may be a multiple and/or fraction of a mobility management measurement gap periodicity. The UE may measure the reference signal during the measurement gap at the multiple and/or fraction of the mobility measurement gap periodicity. In this way, measurement gaps may be used (e.g., shared) for both mobility management measurements and reference signal measurements. For example, the mobility management measurement gap periodicity may be 20 ms, 40 ms, 80 ms, or other suitable periodicity while the reference signal measurement gap periodicity may be an integer multiple (e.g., 2, 4, 8, 10, 16, etc.) of the mobility management measurement gap periodicity. In some aspects, the multiple of the mobility management measurement gap periodicity may be based on a number of inter-frequency layers associated with mobility management measurements by the UE.

In some aspects, the UE may measure a time synchronization parameter and/or a frequency synchronization parameter associated with the reference signal in the first frequency band. For example, the UE may measure a timing advance parameter and/or a frequency compensation parameter associated with the reference signal.

In some aspects, the UE may measure the RSRP of the reference signal using multiple antennas of the UE. The UE may have multiple antennas (e.g., 2, 4, 8, 16, or any suitable number of antennas). Each of the multiple antennas may be oriented in a different direction to enable spatial diversity of the transmitted signals and/or the receive signals. As a non-limiting example, the UE may have a first antenna and a second antenna. The first and second antennas may have main lobes oriented 180 degrees from each other. The UE may measure the RSRP of the reference signal in the first frequency band using both the first and second antennas. The antenna having the highest measured RSRP may be associated with a higher quality channel between the UE and network unit.

At action 820, the method 800 includes the network unit receiving a communication from the UE in the first frequency band. The communication may be received based on the reference signal measurement(s) by the UE. In the regard, the first frequency band may include a supplemental uplink carrier (SUL). The first frequency band may be lower than the second frequency band and provide additional (e.g., supplemental) uplink coverage for the UE. For example, the second frequency band may provide a primary uplink carrier for the UE. The coverage range for the first frequency band may be larger than the coverage range for the second frequency band due to the first frequency band being lower than the second frequency band. The network unit may receive communications from the UE using the first frequency band and/or the second frequency band when the UE is in the coverage range of the first and second frequency bands. When the UE is in coverage range of the first frequency band and out of coverage range of the second frequency band, the network unit may receive communications from the UE using the first frequency band (e.g., the supplemental uplink carrier).

In some aspects, the UE may transmit the communication to the network unit using a transmit power based on a measured pathloss. In this regard, the UE may determine a pathloss based on the reference signal measurement(s). The UE may transmit the communication using a transmit power based on the determined pathloss.

In some aspects, the UE may transmit the communication based on a time synchronization parameter (e.g., timing advance parameter) and/or a frequency synchronization parameter (e.g., doppler shift) associated with the reference signal. In this regard, the UE may determine the time synchronization parameter and/or a frequency synchronization parameter based on the reference signal measurement(s). The UE may transmit the communication based on the time synchronization parameter and/or the frequency synchronization parameter.

Further aspects of the present disclosure include the following:

Aspect 1 includes a method of wireless communication performed by a user equipment (UE), the method comprising receiving, from a network unit, a reference signal in a first frequency band; measuring the reference signal; and transmitting a communication in the first frequency band based on the measurement, wherein the UE is configured with a supplementary uplink (SUL) carrier on the first frequency band.

Aspect 2 includes the method of aspect 1, wherein the receiving the reference signal in the first frequency band comprises performing a blind signal detection across a frequency range, wherein the frequency range includes the first frequency band.

Aspect 3 includes the method of any of aspects 1-2, further comprising receiving, from the network unit via a signal in a second frequency band, a configuration associated with the first frequency band, wherein the receiving the reference signal in the first frequency band is based on the configuration.

Aspect 4 includes the method of any of aspects 1-3, wherein the receiving the configuration comprises receiving the configuration in at least one of a broadcast communication or a radio resource control (RRC) communication.

Aspect 5 includes the method of any of aspects 1-4, wherein the configuration comprises at least one of radio access technology (RAT) indicator associated with the first frequency band; a transmit power associated with the reference signal; a frequency resource indicator associated with the reference signal; a time resource indicator associated with the reference signal; or one or more open loop transmit power control parameters associated with the first frequency band.

Aspect 6 includes the method of any of aspects 1-5, wherein the configuration comprises the RAT indicator, wherein the RAT indicator indicates a new radio (NR) RAT; the reference signal comprises a synchronization signal block (SSB); and the time resource indicator associated with the reference signal comprises a SSB measurement timing configuration (SMTC).

Aspect 7 includes the method of any of aspects 1-6, wherein the configuration comprises the RAT indicator, wherein the RAT indicator indicates a long term evolution (LTE) RAT; and the reference signal comprises at least one of a secondary synchronization signal (SSS); or a cell specific reference signal (CRS).

Aspect 8 includes the method of any of aspects 1-7, further comprising transmitting, to the network unit, an indicator indicating a measurement gap associated with measuring the reference signal in the first frequency band, wherein the measuring the reference signal comprises measuring the reference signal during the measurement gap.

Aspect 9 includes the method of any of aspects 1-8, further comprising transmitting, to the network unit, an indicator indicating at least one of a measurement gap periodicity or a measurement gap length, wherein the measurement gap is based on the at least one of the measurement gap periodicity or the measurement gap length.

Aspect 10 includes the method of any of aspects 1-9, wherein the measurement gap periodicity comprises a multiple of a mobility management measurement gap periodicity.

Aspect 11 includes the method of any of aspects 1-10, wherein the multiple of the mobility management measurement gap periodicity is based on a number of inter-frequency layers associated with mobility management measurements by the UE.

Aspect 12 includes the method of any of aspects 1-11, wherein the measuring the reference signal comprises measuring the reference signal without a measurement gap.

Aspect 13 includes the method of any of aspects 1-12, wherein the measuring the reference signal comprises measuring a pathloss between the UE and the network unit in the first frequency band; and the transmitting the communication in the first frequency band comprises transmitting the communication using a transmit power based on the measured pathloss.

Aspect 14 includes the method of any of aspects 1-13, wherein the measuring the reference signal comprises measuring at least one of a time synchronization parameter or a frequency synchronization parameter in the first frequency band; and the transmitting the communication in the first frequency band comprises transmitting the communication based on at least one of the time synchronization parameter or the frequency synchronization parameter.

Aspect 15 includes the method of any of aspects 1-14, wherein the measuring the reference signal comprises measuring a reference signal received power (RSRP) of the reference signal using multiple antennas in the first frequency band; and the transmitting the communication in the first frequency band comprises transmitting the communication using one or more antennas of the multiple antennas having a highest measured RSRP.

Aspect 16 includes a method of wireless communication performed by a network unit, the method transmitting, to a user equipment (UE), via a signal in a second frequency band, a configuration associated with a supplemental uplink carrier in a first frequency band, wherein the configuration comprises one or more parameters associated with a reference signal transmitted by the network unit in the first frequency band and receiving, from the UE, an uplink communication in the first frequency band based on the one or more parameters.

Aspect 17 includes the method of aspect 16, wherein the transmitting the configuration comprises transmitting the configuration in at least one of a broadcast communication or a radio resource control (RRC) communication.

Aspect 18 includes the method of any of aspects 16-17, wherein the configuration comprises at least one of a radio access technology (RAT) indicator associated with the first frequency band; a transmit power associated with a reference signal in the first frequency band; a frequency resource indicator associated with the reference signal; a time resource indicator associated with the reference signal; or one or more open loop transmit power control parameters associated with the first frequency band.

Aspect 19 includes the method of any of aspects 16-18, further comprising receiving, from the UE, an indicator indicating a measurement gap associated with measuring a reference signal in the first frequency band.

Aspect 20 includes the method of any of aspects 16-19, further comprising receiving, from the UE, an indicator indicating that the UE does not require a measurement gap for measuring a reference signal in the first frequency band.

Aspect 21 includes a non-transitory computer-readable medium storing one or more instructions for wireless communication, the one or more instructions comprising one or more instructions that, when executed by one or more processors of a UE, cause the UE to perform any one of aspects 1-15.

Aspect 22 includes a non-transitory computer-readable medium storing one or more instructions for wireless communication, the one or more instructions comprising one or more instructions that, when executed by one or more processors of a network unit, cause the network unit to perform any one of aspects 16-20.

Aspect 23 includes a user equipment (UE) comprising one or more means to perform any one or more of aspects 1-15.

Aspect 24 includes a network unit comprising one or more means to perform any one or more of aspects 16-20.

Aspect 25 includes a user equipment (UE) comprising a memory; a transceiver; and at least one processor coupled to the memory and the transceiver, wherein the UE is configured to perform any one or more of aspects 1-15.

Aspect 26 includes a network unit comprising a memory; a transceiver; and at least one processor coupled to the memory and the transceiver, wherein the network unit is configured to perform any one or more of aspects 16-20.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
receiving, from a network unit, a reference signal in a first frequency band;
measuring the reference signal; and
transmitting a communication in the first frequency band based on the measurement, wherein the UE is configured with a supplementary uplink (SUL) carrier on the first frequency band.

2. The method of claim 1, wherein the receiving the reference signal in the first frequency band comprises performing a blind signal detection across a frequency range, wherein the frequency range includes the first frequency band.

3. The method of claim 1, further comprising:
receiving, from the network unit via a signal in a second frequency band, a configuration associated with the first frequency band, wherein the receiving the reference signal in the first frequency band is based on the configuration.

4. The method of claim 3, wherein the configuration comprises at least one of:
a radio access technology (RAT) indicator associated with the first frequency band;
a transmit power associated with the reference signal;
a frequency resource indicator associated with the reference signal;
a time resource indicator associated with the reference signal; or
one or more open loop transmit power control parameters associated with the first frequency band.

5. The method of claim 1, further comprising:
transmitting, to the network unit, an indicator indicating a measurement gap associated with measuring the reference signal in the first frequency band, wherein the measuring the reference signal comprises measuring the reference signal during the measurement gap.

6. The method of claim 5, further comprising:
transmitting, to the network unit, an indicator indicating at least one of a measurement gap periodicity or a measurement gap length, wherein the measurement gap is based on the at least one of the measurement gap periodicity or the measurement gap length.

7. The method of claim 1, wherein the measuring the reference signal comprises measuring the reference signal without a measurement gap.

8. The method of claim 1, wherein:
the measuring the reference signal comprises measuring a pathloss between the UE and the network unit in the first frequency band; and
the transmitting the communication in the first frequency band comprises transmitting the communication using a transmit power based on the measured pathloss.

9. The method of claim 1, wherein:
the measuring the reference signal comprises measuring at least one of a time synchronization parameter or a frequency synchronization parameter in the first frequency band; and
the transmitting the communication in the first frequency band comprises transmitting the communication based on at least one of the time synchronization parameter or the frequency synchronization parameter.

10. The method of claim 1, wherein:
the measuring the reference signal comprises measuring a reference signal received power (RSRP) of the reference signal using multiple antennas in the first frequency band; and
the transmitting the communication in the first frequency band comprises transmitting the communication using one or more antennas of the multiple antennas having a highest measured RSRP.

11. A method of wireless communication performed by a network unit, the method comprising:
transmitting, to a user equipment (UE), via a signal in a second frequency band, a configuration associated with a supplemental uplink carrier in a first frequency band, wherein the configuration comprises one or more parameters associated with a reference signal transmitted by the network unit in the first frequency band; and
receiving, from the UE, an uplink communication in the first frequency band based on the one or more parameters.

12. The method of claim 11, wherein the transmitting the configuration comprises transmitting the configuration in at least one of a broadcast communication or a radio resource control (RRC) communication.

13. The method of claim 11, wherein the configuration comprises at least one of:
a radio access technology (RAT) indicator associated with the first frequency band;
a transmit power associated with a reference signal in the first frequency band;
a frequency resource indicator associated with the reference signal;
a time resource indicator associated with the reference signal; or
one or more open loop transmit power control parameters associated with the first frequency band.

14. The method of claim 11, further comprising:
receiving, from the UE, an indicator indicating a measurement gap associated with measuring a reference signal in the first frequency band; and
transmitting a measurement gap configuration to the UE based on the indicator.

15. The method of claim 11, further comprising:
receiving, from the UE, an indicator indicating that the UE does not require a measurement gap for measuring a reference signal in the first frequency band; and
refraining from transmitting a measurement gap configuration to the UE.

16. A user equipment (UE) comprising:
a memory;
a transceiver; and
at least one processor coupled to the memory and the transceiver, wherein the UE is configured to:
receive, from a network unit, a reference signal in a first frequency band;
measure the reference signal; and
transmit a communication in the first frequency band based on the measurement, wherein the UE is configured with a supplementary uplink (SUL) carrier on the first frequency band.

17. The UE of claim 16, wherein the UE is further configured to perform a blind signal detection across a frequency range, wherein the frequency range includes the first frequency band.

18. The UE of claim 16, wherein the UE is further configured to:
receive, from the network unit via a signal in a second frequency band, a configuration associated with the first frequency band, wherein the receiving the reference signal in the first frequency band is based on the configuration.

19. The UE of claim 18, wherein the configuration comprises at least one of:
a radio access technology (RAT) indicator associated with the first frequency band;
a transmit power associated with the reference signal;
a frequency resource indicator associated with the reference signal;
a time resource indicator associated with the reference signal; or
one or more open loop transmit power control parameters associated with the first frequency band.

20. The UE of claim 16, wherein the UE is further configured to:
transmit, to the network unit, an indicator indicating a measurement gap associated with measuring the reference signal in the first frequency band, wherein the measuring the reference signal comprises measuring the reference signal during the measurement gap.

21. The UE of claim 20, wherein the UE is further configured to:
transmit, to the network unit, an indicator indicating at least one of a measurement gap periodicity or a measurement gap length, wherein the measurement gap is based on the at least one of the measurement gap periodicity or the measurement gap length.

22. The UE of claim 16, wherein the UE is further configured to:
measure the reference signal without a measurement gap.

23. The UE of claim 16, wherein the UE is further configured to:
measure a pathloss between the UE and the network unit in the first frequency band; and
transmit the communication using a transmit power based on the measured pathloss.

24. The UE of claim 16, wherein the UE is further configured to:
measure at least one of a time synchronization parameter or a frequency synchronization parameter in the first frequency band; and
transmit the communication based on at least one of the time synchronization parameter or the frequency synchronization parameter.

25. The UE of claim 16, wherein the UE is further configured to:
measure a reference signal received power (RSRP) of the reference signal using multiple antennas in the first frequency band; and
transmit the communication using one or more antennas of the multiple antennas having a highest measured RSRP.

26. A network unit comprising:
a memory;
a transceiver; and
at least one processor coupled to the memory and the transceiver, wherein the network unit is configured to:
transmit, to a user equipment (UE), via a signal in a second frequency band, a configuration associated with a supplemental uplink carrier in a first frequency band, wherein the configuration comprises one or more parameters associated with a reference signal transmitted by the network unit in the first frequency band; and
receive, from the UE, an uplink communication in the first frequency band based on the one or more parameters.

27. The network unit of claim 26, wherein the network unit is further configured to:
transmit the configuration in at least one of a broadcast communication or a radio resource control (RRC) communication.

28. The network unit of claim 26, wherein the configuration comprises at least one of:
a radio access technology (RAT) indicator associated with the first frequency band;
a transmit power associated with a reference signal in the first frequency band;
a frequency resource indicator associated with the reference signal;
a time resource indicator associated with the reference signal; or
one or more open loop transmit power control parameters associated with the first frequency band.

29. The network unit of claim 26, wherein the network unit is further configured to:
receive, from the UE, an indicator indicating a measurement gap associated with measuring a reference signal in the first frequency band; and
transmit a measurement gap configuration to the UE based on the indicator.

30. The network unit of claim 26, wherein the network unit is further configured to:
receive, from the UE, an indicator indicating that the UE does not require a measurement gap for measuring a reference signal in the first frequency band; and
refrain from transmitting a measurement gap configuration to the UE.
